(19) United States
(12) Patent Application Publication
(10) Pub. No.: US 2025/0384255 A1
(43) Pub. Date: Dec. 18, 2025

(54) MANIFOLD-CONSTRAINED NEURAL COMPRESSION

(71) Applicants: VANDERBILT UNIVERSITY, Nashville, TN (US); THE REGENTS OF THE UNIVERSITY OF CALIFORNIA, Oakland, CA (US)

(72) Inventors: Soheil Kolouri, Nashville, TN (US); Chayne Thrash, Nashville, TN (US); Ali Abbasi, Nashville, TN (US); Reed W. Andreas, Nashville, TN (US); Parsa Nooralinejad Eslamloo, Oakland, CA (US); Soroush Abbasi Koohpayegani, Oakland, CA (US); Hamed Pirsiavash, Oakland, CA (US)

(21) Appl. No.: 19/236,783

(22) Filed: Jun. 12, 2025

Related U.S. Application Data
(60) Provisional application No. 63/658,954, filed on Jun. 12, 2024.

(51) Int. Cl. G06N 3/0495; G06N 3/0499; G06N 3/084

(52) U.S. Cl. CPC G06N 3/0495; G06N 3/0499; G06N 3/084

(57) ABSTRACT

A method and system for neural network compression using manifold-constrained optimization. The method partitions neural network parameters into segments and employs a generator network that maps from a lower-dimensional input space to a higher-dimensional parameter space. The generator network is initialized with random weights and then frozen, while only the lower-dimensional inputs are optimized during training. This approach constrains the parameter space to a low-dimensional manifold, enabling significant compression rates while maintaining model performance. The compressed representation consists of the generator network parameters (or its random seed) and the optimized lower-dimensional inputs, which can be used to reconstruct the full neural network parameters during inference. The method is applicable to various neural network architectures including vision transformers, residual networks, and large language models, and can be combined with other compression techniques such as quantization, pruning, or low-rank adaptation.

### CROSS REFERENCE TO RELATED APPLICATION

This application claims priority to U.S. Provisional Patent Application No. 63/658,954, filed Jun. 12, 2024, entitled “MCNC: MANIFOLD CONSTRAINED NETWORK COMPRESSION,” which is incorporated herein by reference in its entirety.

### STATEMENT REGARDING FEDERALLY SPONSORED RESEARCH OR DEVELOPMENT

This invention was made with government support under grant numbers 2339898 and 1845216 awarded by the National Science Foundation and by grant numbers HR0011-22-9-0115 and HR0011-21-9-0135 awarded by the Defense Advanced Research Projects Agency. The government has certain rights in the invention.

### BACKGROUND

Recent advancements in artificial intelligence have been driven by large foundational models across diverse tasks, from computer vision to speech and natural language processing. These models have demonstrated outstanding performance but present significant challenges due to their massive size. For example, large language models can contain tens of billions of parameters, requiring substantial memory for storage and significant bandwidth for transmission.

Existing approaches to model compression generally constrain the parameter space through methods such as low-rank approximation, pruning, or quantization. While these methods have shown success, they often result in performance degradation or require specialized hardware for efficient deployment.

There remains a need for compression techniques that can achieve high compression rates while maintaining model performance and compatibility with existing hardware infrastructure.

### SUMMARY

The present disclosure provides systems, methods, and apparatus for neural network compression through a technique called Manifold-Constrained Neural Compression (MCNC). This approach constrains the parameter space of neural networks to low-dimensional, pre-defined manifolds, effectively compressing the networks while maintaining high performance.

In one aspect, a method for compressing a neural network may include: partitioning parameters of a neural network into one or more segments; initializing a generator network with random weights, the generator network configured to map from a lower-dimensional input space to a higher-dimensional parameter space; freezing weights of the generator network; initializing lower-dimensional inputs to the generator network; generating neural network parameters by passing the lower-dimensional inputs through the generator network; and training the neural network by optimizing only the lower-dimensional inputs while keeping the generator network fixed.

In another aspect, a system for neural network compression may include: a memory; and a processor configured to: partition parameters of a neural network into one or more segments; initialize a generator network with random weights, the generator network configured to map from a lower-dimensional input space to a higher-dimensional parameter space; freeze weights of the generator network; initialize lower-dimensional inputs to the generator network; generate neural network parameters by passing the lower-dimensional inputs through the generator network; and train the neural network by optimizing only the lower-dimensional inputs while keeping the generator network fixed.

In yet another aspect, a non-transitory computer-readable medium may store instructions that, when executed by a processor, cause the processor to perform operations including: partitioning parameters of a neural network into one or more segments; initializing a generator network with random weights, the generator network configured to map from a lower-dimensional input space to a higher-dimensional parameter space; freezing weights of the generator network; initializing lower-dimensional inputs to the generator network; generating neural network parameters by passing the lower-dimensional inputs through the generator network; and training the neural network by optimizing only the lower-dimensional inputs while keeping the generator network fixed.

The disclosed techniques may provide several advantages over existing approaches. By constraining optimization to a low-dimensional manifold, MCNC can achieve high compression rates while maintaining model performance. The method is compatible with existing hardware and can be applied to various neural network architectures, including Vision Transformers, ResNet architectures, and Large Language Models. Additionally, MCNC can be used for both training from scratch and parameter-efficient fine-tuning scenarios.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The foregoing summary, as well as the following detailed description of illustrative implementations, is better understood when read in conjunction with the appended drawings. To illustrate the implementations, there are shown in the drawings example constructions; however, the implementations are not limited to the specific methods and instrumentalities disclosed. In the drawings:

FIGS. 1A-1B illustrate an example of the manifold-constrained neural compression technique according to implementations of the disclosure.

FIG. 2 illustrates traversal of a sphere using a 1-dimensional manifold with different activation functions according to implementations of the disclosure.

FIG. 3 is a block diagram of a system for implementing manifold-constrained neural compression according to implementations of the disclosure.

FIG. 4 is a flow diagram of a method for compressing a neural network using manifold-constrained neural compression according to implementations of the disclosure.

### DETAILED DESCRIPTION

The present disclosure provides systems, methods, and apparatus for neural network compression through a technique called Manifold-Constrained Neural Compression (MCNC). This approach constrains the parameter space of neural networks to low-dimensional, pre-defined manifolds, effectively compressing the networks while maintaining high performance. The following description provides specific details for a thorough understanding of the various embodiments. However, one skilled in the art will understand that the invention may be practiced without these details. In some instances, well-known structures and functions have not been shown or described in detail to avoid unnecessarily obscuring the description of the embodiments.

The terminology used in the description presented below is intended to be interpreted in its broadest reasonable manner, even though it is being used in conjunction with a detailed description of certain specific embodiments. Certain terms may even be emphasized; however, any terminology intended to be interpreted in any restricted manner will be overtly and specifically defined as such in this detailed description section.

It should be noted that the examples and embodiments described herein are provided for illustrative purposes, and the present disclosure is not limited to the specific examples shown. Various modifications, additions, and substitutions may be made to the examples without departing from the spirit and scope of the disclosure. The specific methods, structures, and features described below are not limiting but serve to illustrate examples of implementations of the present disclosure.

### Overview

Large neural network models have demonstrated outstanding performance across diverse tasks, from computer vision to speech and natural language processing. However, storing and transmitting these models poses significant challenges due to their massive size. For example, large language models can contain tens of billions of parameters, requiring substantial memory for storage and significant bandwidth for transmission.

The present disclosure introduces Manifold-Constrained Neural Compression (MCNC), a method for compressing neural networks by constraining the parameter space to low-dimensional, pre-defined manifolds. MCNC works by reparameterizing a neural network's weights through a non-linear mapping from a lower-dimensional space to the full parameter space. The method uses a generator network (typically with sinusoidal activation functions) to map a k-dimensional input space to a d-dimensional parameter space (where k<<d), effectively “wrapping” the low-dimensional space around a high-dimensional hypersphere. This allows the network to be represented with significantly fewer parameters while maintaining performance comparable to the uncompressed model. MCNC may be applied to various neural network architectures, including Vision Transformers (ViT), ResNet architectures, and Large Language Models (LLMs), and can be used in both training from scratch and parameter-efficient fine-tuning scenarios.

The present disclosure describes training a deep model with a minimal number of parameters, making it more efficient to communicate models between agents/entities or store on devices with limited memory. The compact representation makes no assumptions about the model size, weight distribution, the number of non-zero parameters, or computational precision, making it orthogonal to methods like weight-sharing, quantization, pruning, and knowledge distillation. Hybrid approaches could integrate Manifold Constrained Neural Compression (MCNC) with these techniques. Below, these methods are briefly reviewed, which aim to reduce the model size and improve the inference time.

A wide variety of methods have been proposed to compress large models. These approaches can generally be grouped into five main techniques: weight sharing, quantization, pruning, knowledge distillation, and reparameterization. The reparameterization approaches aim to reduce the number of parameters or simplify the computations by restructuring the model weights. This often involves parameterizing the weights through more efficient forms, such as low-rank matrices, which can maintain the model's expressiveness while significantly reducing computational and memory overhead. The present disclosure introduces a novel non-linear reparameterization technique for model compression, which achieves unprecedented performance at extreme compression rates while reducing the CPU-to-GPU transfer time when loading networks.

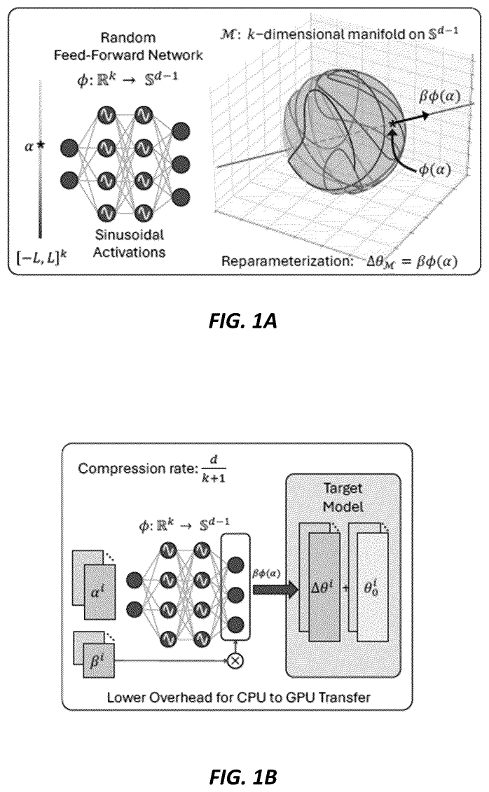

The present disclosure improves upon prior techniques by expanding the complexity of the search space from a random subspace to a k-dimensional nonlinear manifold that more efficiently captures the structure of the parameter space. In particular, as shown in FIGS. 1A and 1B, there is illustrated an example reparameterization technique, Manifold Constrained Network Compression (MCNC), in accordance with aspects of the present disclosure. As shown in FIG. 1A, the parameters θ∈ [symbol] ^{d} are decomposed as θ=θ₀+Δθ, where θ₀ is fixed and Δθ=βu represents the learnable residuals. Here, β is the amplitude, and u∈ [symbol] ^{d-1} is a unit vector on the d-dimensional hypersphere. The unit vector u is generated by mapping a lower-dimensional vector α∈ [symbol] ^{k} through a nonlinear generator ϕ: [symbol] ^{k}→ [symbol] ^{d-1}, allowing the learnable perturbation to lie within a k-dimensional subspace wrapped around the hypersphere. FIG. 1B depicts the model partitioning strategy, where the weights are divided into d-dimensional chunks, and the corresponding (α, β) pairs are learned for each chunk.

As shown in FIG. 1A, one approach is winding a string around a sphere. This approach considers optimizing a model with parameters θ∈ [symbol] ^{d}, where θ=θ₀+Δθ, with θ₀ fixed. Polar decomposition may be expressed as Δθ=βu, where β★ [symbol] is amplitude and

$$u = \frac{Δ θ}{{‖ Δθ ‖}_{2}} ∈ {𝕊}^{d - 1}$$

represents the direction on the hypersphere [symbol] ^{d-1}. Now, consider a segment of the real line [−L, L], representing a string of length 2L, wrapped around [symbol] ^{d-1}, parameterizing a one-dimensional manifold with α∈[−L, L]. Instead of optimizing in d-dimensional space, this method optimizes over the amplitude β and the manifold parameter α. FIG. 1B illustrates this for d=3. Extending this, the segment with a k-dimensional space [−L, L]^{k} is replaced, wrapping it around [symbol] ^{d-1} to increase coverage. This reduces the parameter space from d to k+1, reparameterizing θ by α and β. To wind such a k-dimensional subspace around the d-dimensional hypersphere [symbol] ^{d-1}, a random feedforward neural network may be used with sinusoidal activations, which is referred to herein as a ‘random generator.’ Sinusoidal activations introduce periodicity in parameterization, facilitating smoother and more uniform coverage of the hypersphere and enhancing the differentiability of the generator.

Thus, the novel non-linear reparameterization technique for model compression of the present disclosure restricts the optimization of network parameters to a-dimensional manifold within the original-dimensional parameter space, enabling more efficient compression. The present disclosure also demonstrates the effectiveness of the disclosed method compared to recent network compression methods in the literature across vision and natural language processing tasks and across diverse architectures.

### Example Methods

MCNC relies on two components: 1) an explicit nonlinear mapping that wraps a k-dimensional space around a sphere in a d-dimensional space, where k<<d, and 2) partitioning the model's parameters into d-dimensional segments and optimizing them in the k-dimensional input space of the nonlinear map. This process would result in a compression rate of almost d/k.

To introduce the method of the present disclosure, let θ∈ [symbol] ^{d} denote a partition of the model parameters, which are sought to be optimized. Through polar decomposition, θ is expressed by its amplitude β=∥θ∥ and its direction u=θ/∥θ∥₂. Additionally, the d-dimensional unit sphere is dentied with [symbol] ^{d-1}. A goal is to reparameterize u∈ [symbol] ^{d-1} using significantly fewer parameters than d. To achieve this, a ‘generator’ model is used to explicitly parameterize a k-dimensional manifold that best represents the d-dimensional hypersphere.

### Traversing a High-Dimensional Sphere by a Low-Dimensional Manifold

The present disclosure aims to model a-dimensional hypersphere using a-dimensional manifold. For example, in a simpler scenario, consider d=3, corresponding to a sphere, and k=1, akin to a string. Given a string of a specific length, to most effectively cover the surface of the sphere the string may be simply wrapped around the sphere. This wrapping acts as a nonlinear operator that takes a straight line and deforms it around the sphere. Similarly, a-dimensional input space can be wrapped via a nonlinear function, i.e., a generator, around a hypersphere in the-dimension.

To formalize the problem, to traverse a hypersphere using a low-dimensional manifold, the aim is to maximize its coverage. This problem may be formalized as follows: Let [symbol] ([−L, L]^{k}) be the uniform distribution over the k-dimensional hypercube [−L, L]^{k}, and [symbol] the uniform distribution over the d-dimensional hypersphere [symbol] ^{d-1}. One aim is to develop a nonlinear mapping that wraps the k-dimensional hypercube around the d-dimensional hypersphere, maximizing coverage. This problem may be formalized as finding a nonlinear function ϕ: [symbol] that transforms [symbol] ([−L, L]^{k}) into [symbol] , mapping samples α˜ [symbol] ([−L, L]^{k}) to the hypersphere such that ϕ(α)˜ [symbol] . Hence, there is a need to measure the uniformity of the ϕ(α)s. To do that, the Wasserstein distance is measured between the output probability distribution of ϕ and the uniform distribution on the hypersphere.

The generator, ϕ: [symbol] may be modeled via a feed-forward network. Various activation functions may be considered, such as, the Sigmoid, Rectified Linear Unit (ReLU), and Sine activation. First, it is determed whether a randomly initialized network can provide the desired characteristics. Second, it is determined whether optimize such a generator can be optimzied to provide maximal space traversal. Using the uniform distribution on [symbol] ^{d-1} as a target distribution stems from an assumption of no prior knowledge about the importance of different directions for the downstream task of optimizing a network. Should such information become available, the target distribution could be adjusted to reflect this knowledge, allowing for more precise wrapping around areas of greater importance. The SWGAN framework may be used to train the generator.

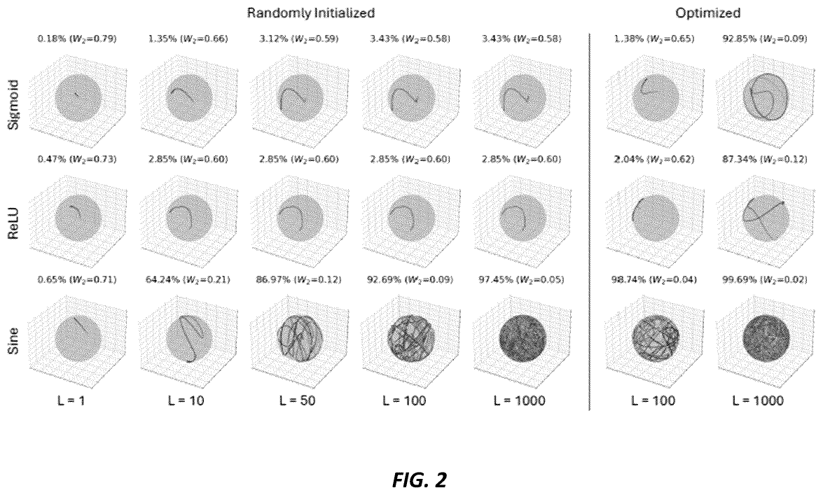

FIG. 2 illustrates traversal of a sphere using a 1-dimensional manifold, where ϕ: [symbol] is a multi-layer perceptron with architecture 1→1024→1024→3 and activation functions Sigmoid, ReLU, or Sine. The input bound L is absorbed into the first layer's weights. The left panel displays outputs of randomly initialized networks for different activations and L values, while the right panel shows outputs after optimization. Uniformity is quantified using

$$exp ( - τ {W}_{2}^{2} ( \hat{μ} , v ) ) ,$$

with τ=10.0 and W₂ representing the Wasserstein distance between the network's output û and the uniform distribution v. As an example for developing the generator, consider the case where k=1, d=3, and ϕ is modeled as a feed-forward network with the architecture 1→1024→1024→3. FIG. 2 shows the output of ϕ for randomly initialized networks with various activation functions, along with the outputs after optimization. Uniformity is evaluated by reporting

$$exp ( - τ {W}_{2}^{2} ( \hat{μ} , v ) ) ,$$

where û is the output distribution of ϕ and v represents the uniform distribution on [symbol] ^{d-1}. For larger values of L, the randomly initialized network with Sine activations achieves strong coverage of the sphere, with optimization only marginally improving the coverage. Therefore, in the main results, a randomly initialized feed-forward network is used with Sine activations as the generator while also conducting an ablation study on the impact of training the generator. Thus, the random generator can be efficiently stored or communicated using a scalar random seed, assuming access to a shared pseudo-random number generator (PRNG).

### Reparameterization and Manifold Constrained Optimization

Given a random generator model, ϕ: [symbol] , may be reparameterized as a d-dimensional residual vector as Δθ=βϕ(α), where β∈ [symbol] and α∈ [symbol] ^{k}, thereby reducing the number of parameters from d to k+1. FIG. 1A illustrates this concept. Let L [symbol] : [symbol] denote the loss function for a specific task of interest, e.g., image classication where [symbol] (θ) is the associated loss with parameter θ. the training of the parameter θ may be constrained as:

$${θ}^{*} = {θ}_{0} + {β}^{*} ϕ ( {α}^{*} ) , ( {α}^{*} , {β}^{*} ) = arg {min}_{α , β} ℒ ( {θ}_{0} + βϕ ( α ) ) \qquad ( 1 )$$

θ₀ may be used to emphasize that optimization can begin from any random initialization or pre-trained weights, such as those used in PEFT. This optimization process constrains the model parameters, θ, to lie on a k-dimensional manifold within [symbol] ^{d-1}, which is parameterized by ϕ.

### Learning the Deep Model

The generator ϕ(.) may be initialized randomly and and frozen. Then, given a deep model, its parameters may be reshaped to a long vector and then divided into chunks of size d, and reparameterize each chunk with k+1 parameters using the generator ϕ(.). In the case the model size is not divisible by d, the last chunk will have some extra parameters that will be ignored. Finally, the model may be trained by optimizing (α, β) for all chunks using Eq (1) to minimize the loss of the deep model on the task of interest, e.g., image classification. The backpropagation is as simple as calculating the gradient for model parameters and then using the chain rule to backpropagate through the generator ϕ(.). Hence, auto-differentiation can be directly used to optimize αs and β without the need for geometric optimization techniques.

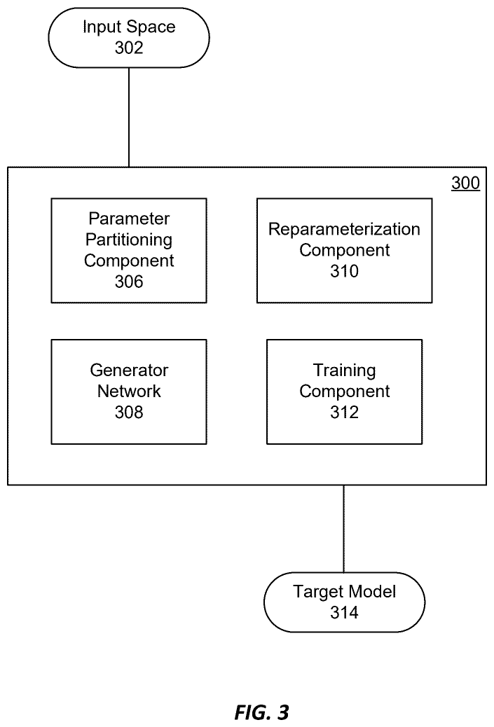

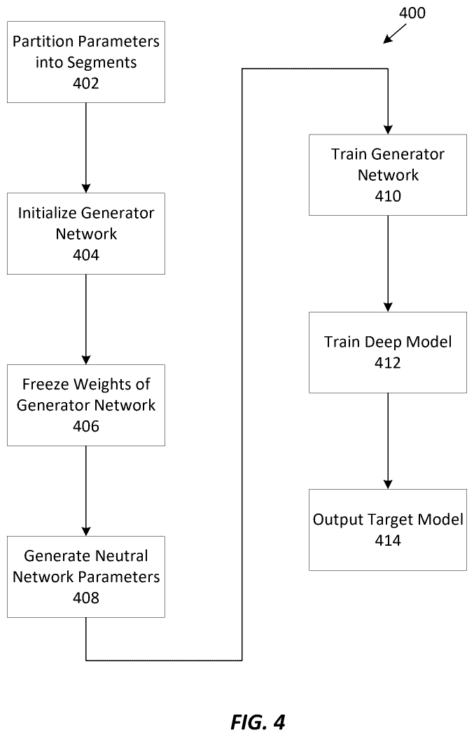

FIG. 3 is a diagram showing an example system 300 for performing manifold-constrained neural compression in accordance with the present disclosure. FIG. 4 is a flow diagram of a method 400 for compressing a neural network using manifold-constrained neural compression within the system of FIG. 3. The method 400 may be implemented by the system 300 of FIG. 3.

At 402, the method 400 may include partitioning parameters of a neural network into one or more segments. An input space 302 may be received by system 300 and passed to a parameter partitioning component 306. The parameters may be partitioned into d-dimensional segments, where d is the dimensionality of the original parameter space.

At 404, the method 400 may include initializing a generator network 308 with random weights. The generator network 308 may be a feed-forward neural network with sinusoidal activation functions, configured to map from a k-dimensional input space to a d-dimensional parameter space, where k<<d.

At 406, the method 400 may include freezing weights of the generator network 308. By freezing the weights, the generator network becomes a fixed mapping from the lower-dimensional input space to the higher-dimensional parameter space.

At 408, the method 400 may include generating neural network parameters by passing the lower-dimensional inputs through the generator network 308. This may be performed by the reparameterization component 310 that performs model compression. The generator network 308 maps the k-dimensional inputs to the d-dimensional parameter space, effectively reconstructing the full neural network parameters.

At 410, the method 400 may include training the generator network 308 by optimizing only the lower-dimensional inputs while keeping the generator network fixed. This may be performed by the training component 312. The optimization may be performed using standard optimization algorithms such as stochastic gradient descent (SGD) or Adam.

At 412, the method 400 may include training a deep model. This may also be performed by the training component 312 to minimize the loss of the deep model on the task of interest, e.g., image classification.

At 414, the method 400 may include outputting a target model 314 where the target model has a reduced size.

The system 300 may be a computing environment that includes one or more processors, a system memory, one or more graphics processors, one or more interface, one or more non-volatile data storage devices, external communication devices, remote computing devices, and cloud-based services. The computing environment may further comprise externally accessible data ports or connections such as serial ports, parallel ports, universal serial bus (USB) ports, and infrared ports and/or transmitter/receivers. The computing environment may further comprise hardware for wireless communication with external devices such as wireless or wired interfaces. The system memory is processor-accessible data storage in the form of volatile and/or nonvolatile memory. Non-volatile memory is not erased when power to the memory is removed, whereas volatile memory is erased when power to the memory is removed.

Thus, as described herein, MCNC offers several advantages over existing compression techniques:
1. High compression rates: MCNC can achieve high compression rates (e.g., 10× or more) while maintaining model performance.
2. Compatibility with existing hardware: MCNC does not require specialized hardware for deployment, unlike some quantization methods.
3. Applicability to various architectures: MCNC can be applied to various neural network architectures, including Vision Transformers, ResNet architectures, and Large Language Models.
4. Reduced CPU-to-GPU transfer time: By decreasing the overall size of the model, MCNC can reduce the time required to transfer the model from CPU to GPU memory.
5. Parameter-efficient fine-tuning: MCNC can be used for parameter-efficient fine-tuning of large pre-trained models, reducing the number of parameters that need to be updated during fine-tuning.

MCNC may be applied in various scenarios, including, but not limited to:
1. Deployment of large models on resource-constrained devices.
2. Efficient transmission of models over networks with limited bandwidth.
3. Reduction of memory requirements for storing large models.
4. Parameter-efficient fine-tuning of large pre-trained models for specific tasks.

### Experimental Results

To demonstrate the performance of the methods described above, an evaluation of MCNC under two different settings is provided: (1) Training from scratch for image classification. In this setting, let θ₀ is a randomly initialized network and optimize using MCNC. Since a randomly initialized network can be communicated using only the random seed, this does not increase the cost of compression. The effectiveness at compressing both Vision Transformer (ViT) and ResNet architectures; and (2) Parameter Efficient Fine-Tuning of LLMs. In this setting, a pre-trained θ* is used and the Δθ is optimzed via MCNC. This experiment is for LLMs where fine-tuning of large models has become the norm.

Given that the method is orthogonal to the low-rank parameterization used in LoRA, the methods herein reparameterize either the original networks or their rank-constrained versions in the experiments.

Training Image Classifiers from Scratch

ImageNet-100 on Vision Transformer Architectures. This begins by evaluating on training Vision Transformers from scratch on the ImageNet-100 dataset, It is evaluated on both ViT-Ti and ViT-S, MCNC is compated against iterative unstructured pruning method PLATON as well as the classic Magnitude pruning, The final compressed model size is reported as a percentage. As unstructured pruning also requires storing the indices of non-zero values, these must be accounted for when computing the compression rate. Although this requires storing two values per weight, the number of bits required for each index can be reduced by storing the distance between each non-zero value, Therefore, half-precision is assumed for the indices and prune to sparsity rates 50% higher than the desired compression. Position embeddings, CLS token, and Layer Normalization parameters ar excluded from all compression methods. Hhyperparameters used for the method and baselines are provided below. Table 1 show results on ViT-Ti and ViT-S. The results show that, particularly for high compression rates, MCNC is more effective than pruning for compression. For ViT-Ti, the present method outperforms pruning by 8% at 10% of the original model size. On ViT-S, although pruning methods are able to outperform at higher compression rates, the method is able to maintain high performance as model size decreased.

TABLE 1
Comparison of The method of the present disclosure with pruning
techniques on ViT-Ti and ViT-S models trained on ImageNet-100.
Position embeddings, CLS token, and Layer Normalization parameters
were excluded when computing the percentage of model size.

| | | |
|---|---|---|
| | Percentage of | |
| Method | Model Size | Acc. |

ViT-Ti

| | | |
|---|---|---|
| Baseline | 100% | 83.5 |
| Magnitude NIPS2015_ae0eb3ee (Pr. 66.7%) | 50% | 80.4 |
| PLATON zhang2022platon (Pr. 66.7%) | | 81.6 |
| MCNC (Ours) | | 80.0 |
| Magnitude NIPS2015_ae0eb3ee (Pr. 86.7%) | 20% | 73.0 |
| PLATON zhang2022platon (Pr. 86.7%) | | 76.1 |
| MCNC (Ours) | | 77.1 |
| Magnitude NIPS2015_ae0eb3ee (Pr. 93.3%) | 10% | 60.9 |
| PLATON zhang2022platon (Pr. 93.3%) | | 67.2 |
| MCNC (Ours) | | 72.9 |
| Magnitude NIPS2015_ae0eb3ee (Pr. 96.7%) | 5% | 45.8 |
| PLATON zhang2022platon (Pr. 96.7%) | | 55.0 |
| MCNC (Ours) | | 69.1 |
| Magnitude NIPS2015_ae0eb3ee (Pr. 98.7%) | 2% | 29.4 |
| PLATON zhang2022platon (Pr. 98.7%) | | 39.0 |
| MCNC (Ours) | | 61.3 |
| Magnitude NIPS2015_ae0eb3ee (Pr. 99.3%) | 1% | 21.2 |
| PLATON zhang2022platon (Pr. 99.3%) | | 30.6 |
| MCNC (Ours) | | 52.9 |

ViT-S

| | | |
|---|---|---|
| Baseline | 100% | 83.9 |
| Magnitude NIPS2015_ae0eb3ee (Pr. 83.3%) | 25% | 79.8 |
| PLATON zhang2022platon (Pr. 83.3%) | | 82.2 |
| MCNC (Ours) | | 82.7 |
| Magnitude NIPS2015_ae0eb3ee (Pr. 93.3%) | 10% | 72.0 |
| PLATON zhang2022platon (Pr. 93.3%) | | 77.4 |
| MCNC (Ours) | | 80.2 |
| Magnitude NIPS2015_ae0eb3ee (Pr. 96.7%) | 5% | 66.0 |
| PLATON zhang2022platon (Pr. 96.7%) | | 71.1 |
| MCNC (Ours) | | 76.3 |
| Magnitude NIPS2015_ae0eb3ee (Pr. 98.7%) | 2% | 41.5 |
| PLATON zhang2022platon (Pr. 98.7%) | | 57.6 |
| MCNC (Ours) | | 66.7 |

ImageNet-100 on ResNet-18. Next, it is shown that the method works across architectures by training from scratch on ImageNet-100 using the ResNet-18 architecture. A comparision with other recent network reparameterization methods PRANC and NOLA is provided. Since it was shown in that reparameterizing LoRA rather than the original model architecture can boost performance, also shown are results of the method of the present disclsoure in this setting. Results are shown in Table 2. The method of the present disclosure demonstrates a 7% accuracy improvement over the baselines at 1% of the original model size. In addition, as the compression rate can be reducuded, it is sown that up to 97% of the original model accuracy can be reocvered at 10% of the size.

TABLE 2
Comparison with PRANC and NOLA on ImageNet-100 using
ResNet-18 with multiple compression rates.

| Method | Ref | Percentage of Model Size | Acc. |
|---|---|---|---|
| Baseline | — | 100% | 82.1 |
| Ours | — | 50% | 80.7 ± 0.4 |
| Ours w/LoRA | — | | 79.1 ± 0.7 |
| Ours | — | 20% | 79.9 ± 0.3 |
| Ours w/LoRA | — | | 80.0 ± 0.2 |
| Ours | — | 10% | 78.0 ± 0.0 |
| Ours w/LoRA | — | | 80.3 ± 0.5 |
| Ours | — | 5% | 75.4 ± 0.2 |
| Ours w/LoRA | — | | 79.6 ± 0.1 |
| PRANC 2023 | 2023 | 2% | 67.3 |
| Ours | — | | 70.2 ± 0.1 |
| Ours w/LoRA | — | | 76.9 ± 0.2 |
| PRANC 2023 | 2023 | 1% | 61.1 |
| NOLA 2024 | 2024 | | 64.7 |
| Ours | — | | 63.4 ± 0.2 |
| Ours w/LoRA | — | | 71.7 ± 0.3 |

CIFAR-10 and CIFAR-100. We compare MCNC on CIFAR-7. and CIFAR-100 with both pruning methods as well as PRANC and NOLA under extreme compression rates are compared. The results on the two datasets using both ResNet-20 and ResNet-56 are shown. For the pruning methods and PRANC, the results reported are directly compared. The results for these experiments are prsented in Table 3. It can be seen that MCNC is able to consistently outperform all other methods while using a similar number of parameters. In addition, just as NOLA improves upon PRANC with the addition of LoRA, MCNC gains a boost as well.

TABLE 3
Comparison of The method of the present disclosure with pruning
methods as well as PRANC and NOLA. We include results for The
method of the present disclosure with and without LoRA applied
to each of the layers. As none of the methods compress BatchNorm
parameters, we remove them from all parameter counts.

| Method | Ref | Arch. | Dataset | # Params | Acc. |
|---|---|---|---|---|---|
| Baseline | — | R20 | C10 | 269,722 | 88.9 |
| STR 2020a | 2023 | R20 | C10 | 12,238 | 76.0 |
| PRANC 2023 | 2023 | R20 | C10 | 10,000 | 81.5 |
| NOLA 2024 | 2024 | R20 | C10 | 11,500 | 82.4 |
| MCNC (Ours) w/o LoRA | — | R20 | C10 | 10,380 | 82.3 ± 0.3 |
| MCNC (Ours) w/LoRA | — | R20 | C10 | 9,640 | 83.9 ± 0.1 |
| Baseline | — | R56 | C10 | 853,018 | 91.6 |
| DPF 2020 | 2023 | R56 | C10 | 13,414 | 47.7 |
| SuRP 2022 | 2023 | R56 | C10 | 10,834 | 66.7 |
| STR 2020a | 2023 | R56 | C10 | 13,312 | 67.8 |
| PRANC 2023 | 2024 | R56 | C10 | 5,000 | 76.9 |
| NOLA 2024 | — | R56 | C10 | 5,000 | 78.5 ± 0.1 |
| MCNC (Ours) w/o LoRA | — | R56 | C10 | 5,280 | 78.7 ± 0.2 |
| MCNC (Ours) w/LoRA | — | R56 | C10 | 5,590 | 81.5 ± 0.2 |
| Baseline | — | R20 | C100 | 275,572 | 60.8 |
| DPF 2020 | 2023 | R20 | C100 | 10,770 | 12.2 |
| SuRP 2022 | 2023 | R20 | C100 | 6,797 | 14.5 |
| STR 2020a | 2023 | R20 | C100 | 10,673 | 13.2 |
| PRANC 2023 | 2023 | R20 | C100 | 5,000 | 32.3 |
| NOLA 2024 | — | R20 | C100 | 5,180 | 35.6 ± 0.1 |
| MCNC (Ours) w/o LoRA | — | R20 | C100 | 5,110 | 34.7 ± 0.2 |
| MCNC (Ours) w/LoRA | — | R20 | C100 | 5,070 | 36.7 ± 0.2 |
| Baseline | — | R56 | C100 | 858,868 | 64.3 |
| DPF 2020 | 2023 | R56 | C100 | 19,264 | 19.1 |
| SuRP 2022 | 2023 | R56 | C100 | 10,919 | 14.6 |
| STR 2020a | 2023 | R56 | C100 | 18,881 | 26.0 |
| PRANC 2023 | 2023 | R56 | C100 | 5,000 | 33.0 |
| NOLA 2024 | — | R56 | C100 | 5,000 | 36.2 ± 0.6 |
| MCNC (Ours) w/o LoRA | — | R56 | C100 | 5,049 | 35.2 ± 0.1 |
| MCNC (Ours) w/LoRA | — | R56 | C100 | 5,015 | 36.5 ± 0.8 |

### MCNC for Fine-tuning Large Language Models

Below, the performance of MCNC and NOLA in parameter-efficient fine-tuning are compared. Fine-tuning experiments were conducted on two variants of the LLaMA-2 language model, LLaMA 7B, and LLaMA 13B, using the Alpaca dataset as the training data, Both training loss and validation loss on the Alpaca dataset is reported. Additionally, MMLU (Massively Multitask Language Understanding) 5-shot accuracy following the standard practice is reported. This benchmark spans 57 tasks across diverse fields such as computer science, mathematics, law, and history.

The training code from QLoRA and NOLA for the experiments was used. The original parameters of the language model was quantized to 4-bit and apply and fine-tune the adapter on all layers of the transformer. The rank was set to 8 for both NOLA and The method of the present disclosure in LLaMA 7B, and to 16 in LLaMA 13B. In the method of the present disclosure, a generator with the following specifications was sued: a 3-layer MLP with an input dimension of 5, an output dimension of 5000, and a hidden dimension of 32. In NOLA, 64 bases for A and B in LLaMA 7B and 140 bases for LLaMA 13B was used. These numbers of bases result in the same number of optimized parameters as The method of the present disclosure for each architecture. All other hyperparameters were identical for both methods except the learning rate; lr=0.001 for NOLA and 0.01 was used herein.

The results are presented in Table 4. MCNC has comparable performance to NOLA with a similar number of parameters. However, MCNC requires 46% fewer GFLOPs for generating parameters on the fly compared to NOLA. This efficiency translates into faster inference and training for MCNC compared to NOLA. As shown in Table 4, MCNC achieves double the throughput for LLaMA 7B and 2.2 times higher throughput for LLaMA 13B. While it is feasible to generate parameters offline and merge them with the original weights of the language model, this approach limits the applications when processing multiple tasks and their corresponding adapters in a batch. Therefore, in scenarios involving batch processing of tasks, MCNC holds an advantage over NOLA due to its faster throughput.

TABLE 4
Instruction finetuning for quantized LLaMA-2: We fine-tune LLaMA-2 with the Alpaca
dataset and compare MCNC to NOLA, maintaining the same number of parameters for both.
“Generation GFLOPs” refers to the FLOPs needed to generate the original parameters
of the adapter on the fly. MCNC achieves comparable performance to NOLA while requiring
fewer FLOPs for on-the-fly parameter generation. This efficiency results in faster
inference and training for MCNC compared to NOLA. We use a single RTX 3090 GPU to
calculate the throughput. Note that the throughput here includes both the adapter's
reconstruction and the forward pass through the base model and adapter.

| | | | | | | |
|---|---|---|---|---|---|---|
| | | | | | Throughput | Adapter Model |
| | Trainable | MMLU | Train | Val | (Samples/ | Reconstruction |
| Method | Parameters | Acc | Loss | Loss | Sec) | GFLOPs |

LLaMA-2- 7B (4-bit)

| | | | | | | |
|---|---|---|---|---|---|---|
| LoRA (rank = 1) 2022 | 2.5M | 45.6 | 0.98 | 1.06 | 7.1 | — |
| NOLA 2024 | 28k | 45.5 | 1.08 | 1.01 | 3.1 | 2.56 |
| MCNC | 25k | 45.9 | 1.03 | 1.01 | 6.2 | 1.37 |

LLaMA-2- 13B (4-bit)

| | | | | | | |
|---|---|---|---|---|---|---|
| LoRA (rank = 1) 2022 | 3.9M | 54.8 | 0.94 | 0.97 | 4.1 | — |
| NOLA 2024 | 78k | 54.8 | 1.00 | 0.96 | 1.7 | 17.53 |
| MCNC | 77k | 55.0 | 1.00 | 0.95 | 3.9 | 4.22 |

### Ablation Studies

In the previous experiments, the effectiveness of the method in training large models constrained to our low dimensional manifold is demostrated. However, as the manifold is modeled as a neural network, the design space of the manifold itself is large. Below, the effect of various design decisions by applying different generator variations to the task of MNIST classification is explored.

Effect of choice of activation function: Above, it is shown that for k=1 and d=3, a randomly initialized MLP with sinusoid activations can effectively cover [symbol] ^{d-1}. For this reason, Sine was selected as an activation function. Is this coverage is truly important and whether other activation functions may actually provide better performance?This is shown in Table 5 by comparing against ReLU, Leaky ReLU, ELU, Sigmoid, and no activation function. For the no activation experiment, it is not necessary to train a separate amplitude as the magnitude of the inputs directly control the output magnitudes. Instead, this additional parameter is added as an additional input to the generator. From the results shown, it can be seen that many activation function choices are actively harmful and perform worse than none. Sigmoid and Sine activations are the only ones that outperform none with Sine performing the best. Importantly, when no activation is used, The method of the present disclosure recovers a variation of PRANC,

TABLE 5
The impact of MCNC activation function on MNIST classification.

| Activation Function | Acc. |
|---|---|
| None (linear) | 81.6 ± 0.5 |
| ReLU | 76.0 ± 2.8 |
| Leaky ReLU | 76.9 ± 1.6 |
| ELU | 81.3 ± 0.2 |
| Sigmoid | 83.7 ± 0.7 |
| Sine | 84.6 ± 0.7 |

Effect of generator input frequency: As described above, the magnitude of the input to the generator, i.e., L, controls the number of twists and turns in the manifold. While this twisting is necessary to effectively cover a high dimensional space, it is also likely to increase optimization difficulty. It's worth asking then how different settings of this value affect compression of downstream models. To test this, the inputs to the generator are multipiled by a constant associated with the frequency and show results in Table 6. It's immediately apparent that higher frequencies are necessary to achieve high performance as a frequency value of 1.0 performs similarly to a linear generator. Small increases in frequency greatly increase performance until saturation at 4.0.

TABLE 6
The effect of frequency of first layer of
Sine activations on the accuracy of MNIST.

| Input Frequency | Acc. |
|---|---|
| 1.0 | 81.9 ± 0.4 |
| 2.0 | 83.5 ± 0.2 |
| 4.0 | 85.1 ± 0.2 |
| 8.0 | 84.7 ± 0.4 |
| 16.0 | 85.0 ± 0.4 |
| 32.0 | 85.5 ± 0.4 |

Varying model size with fixed number of compressed parameters: A unique aspect of MCNC is that the total number of trainable parameters can be fixed regardless of the number of model parameters by varying its compression rate. This allows a study of how performance scales as model complexity increases while the number of trainable parameters remains the same. As model complexity increases, the number of good solutions should increase. Thus, this over-parameterization will facilitate finding high performing compressed models regardless of the number of trainable parameters. The MLP hidden size was varied while maintaining the number of trainable parameters from the previous experiments and present the results in Table 7. As expected, a consistent increase in accuracy is shown as model size increases. While smaller architectures can occasionally achieve higher accuracy, the high standard deviations indicate that their optimization often fails to find good solutions.

TABLE 7
Impact of increasing model size with fixed number
of compressed parameters on MNIST classification.

| Hidden Size | Acc. |
|---|---|
| 16 | 81.1 ± 0.3 |
| 32 | 82.5 ± 1.1 |
| 64 | 84.0 ± 0.7 |
| 128 | 83.9 ± 1.3 |
| 256 | 84.6 ± 0.4 |
| 512 | 85.2 ± 0.2 |

Speedup of CPU to GPU transfer: By decreasing the overall size of the model, MCNC can also be used to reduce the time taken to move large models from CPU to GPU. As long as the generator is loaded into GPU memory, only the much smaller set of as must be transferred from CPU to GPU and then expanded into the full model using the generator. To show this can result in a speedup, the time to load ViT-S from CPU to GPU memory was compared with the time to load and expand the as associated with a ViT-S compressed by 100×. This experiment was performed 100 times using an RTX A6000 and report the average timings in Table 8. These results show that, despite having to complete a forward pass of the generator, the transfer time was reduced by half.

TABLE 8
CPU to GPU transfer time of uncompressed/compressed
ViT-S model (100×)

| Uncompressed | Compressed | Speedup |
|---|---|---|
| 35.5 ms | 17.8 ms | 2.0× |

Effect of training on the generator: Above it was demonstrated that training a generator only slightly improves its coverage of the hypersphere. To further investigate the impact of using trained generators, MCNC with both random and trained generators was applied on CIFAR-10/100. The results presented in Table 9 show consistent but only marginal improvements in accuracy when using trained generators. Given the advantages of random generators, including: 1) easy scalability to different compression rates, 2) storage and communication efficiency (only requiring a random seed), and 3) potential cryptographic benefits, we used random generators for our main experiments.

TABLE 9
Impact of using a random vs. trained generator on
CIFAR10/100 classification with different models.

| Arch. | Dataset | Acc. Random | Acc. Trained |
|---|---|---|---|
| R20 | C10 | 82.3 ± 0.3 | 82.4 ± 04 |
| R56 | C10 | 78.7 ± 0.2 | 79.2 ± 02 |
| R20 | C100 | 34.7 ± 0.2 | 36.1 ± 0.6 |
| R56 | C100 | 35.2 ± 0.1 | 36.7 ± 0.5 |

### Recommended Settings for MCNC

### Details on Compressing Image Classifiers

Generator architecture When training from scratch with MCNC, the same Generator configuration was used as listed in Table 10 and set d such that we achieve the desired compression. All linear layers in our generator do not include a bias to guarantee a zero initialization by setting inputs to zero.

TABLE 10
Recommended hyperparameter defaults for MCNC.

| Setting | Recommendation |
|---|---|
| Input Dimension | 9 |
| # of layers | 3 |
| Width | 1000 |
| Input Frequency | 4.5 |
| Weight Initialization | $U ( [ - \frac{1}{n} , \frac{1}{n} ] )$ |
| Optimizer | Adam |
| Learning Rate | 5-10× larger than uncompressed model |

ViT hyperparameters The baseline models used for pruning are trained for 800 epochs using the AdamW optimizer. The batch size was set to 1024 with initial learning rate of 0.001 and use a cosine learning rate scheduler. For all pruning methods, the best learning rate in {5e-4,1e-4,8e-5}per compression rate was searched. Training was for 20 epochs and the parameters of the cubic sparsity scheduler were set to tᵢ=1000, t_{f}=12000. For PLATON, we set β₁=0.85 and β₂=0.95. In addition, for each compression rate it was run both with and without MixUp and CutMix augmentations and take the best results. The AdamW optimizer and a cosine learning rate scheduler was used. For MCNC, trainign was for 800 epochs with a cosine learning rate scheduler using the Adam optimizer. Learning rates and whether Mixup/Cutmix are used for each method are shown in Tables 11 and 12. For pruning methods, the batch size wasset to 128 and 256 was used for MCNC on ViT-Ti and 512 for MCNC on ViT-S.

TABLE 11
Hyperparameters for compressing ViT-Ti

| | Percentage of | | Mixup/Cutmix |
|---|---|---|---|
| Method | Model Size | Learning Rate | Augmentations |
| Magnitude | 50% | 0.0005 | √ |
| PLATON | 50% | 0.0005 | √ |
| MCNC | 50% | 0.001 | √ |
| Magnitude | 20% | 0.0005 | X |
| PLATON | 20% | 0.0005 | X |
| MCNC | 20% | 0.001 | √ |
| Magnitude | 10% | 0.0005 | X |
| PLATON | 10% | 0.0005 | X |
| MCNC | 10% | 0.01 | X |
| Magnitude | 5% | 0.0005 | X |
| PLATON | 5% | 0.0005 | X |
| MCNC | 5% | 0.01 | X |
| Magnitude | 2% | 0.0005 | X |
| PLATON | 2% | 0.0005 | X |
| MCNC | 2% | 0.01 | X |
| Magnitude | 1% | 0.0005 | X |
| PLATON | 1% | 0.0005 | X |
| MCNC | 1% | 0.01 | X |

TABLE 12
Hyperparameters for compressing ViT-S

| | | | Mixup/Cutmix |
|---|---|---|---|
| Method | Percentage of Model Size | Learning Rate | Augmentations |
| Magnitude | 25% | 0.0005 | √ |
| PLATON | 25% | 0.0005 | √ |
| MCNC | 25% | 0.002 | √ |
| Magnitude | 10% | 0.0005 | √ |
| PLATON | 10% | 0.0005 | X |
| MCNC | 10% | 0.002 | √ |
| Magnitude | 5% | 0.0005 | X |
| PLATON | 5% | 0.0005 | X |
| MCNC | 5% | 0.005 | √ |
| Magnitude | 2% | 0.0005 | X |
| PLATON | 2% | 0.0005 | X |
| MCNC | 2% | 0.005 | X |

RsNet hyperparameters For all experiments, the same set of data augmentations as in PRANC was used. Likewise, BatchNorm parameters from compression was excluded and not considered when computing the compression rate. When applying MCNC to ResNet architectures, training was poerfomred for 400 epochs with a learning rate of 0.01 using the Adam optimizer. The learning rate was decayed by 0.5 if the loss has not improved in 4 epochs. When applying LoRA to a convolutional layer with kernel size k and input and output channels c₁ and c₂, it was reshaped be of size kc₁×kc₂ and create low rank matrices A∈ [symbol] ^{kx}^{₁}^{×r}, B∈ [symbol] ^{r×kc}^{₂}. When applying LoRA, rank 64 was used and it was not attempted to find the optimal rank.gmentations as in PRANC. Likewise, we exclude BatchNorm parameters from our compression and do not consider them when computing the compression rate. When applying MCNC to ResNet architectures, we train for 400 epochs with a learning rate of 0.01 an optimizer. We decay the learning rate by 0.5 if the loss has not improved in 4 epochs. When applying LoRA to a convolutional layer with kernel size k and input and output channels c₁ and c₂, we reshape it be of size kc₁×kc₂ and create low rank matrices A∈ [symbol] ^{kc}^{₁}^{×r}, B∈ [symbol] ^{r×kc}^{₂}. When applying LoRA, we use rank 64, and do not attempt to find the optimal rank.

### Ablation Experimental Setup

Unless note otherwise, all ablation experiments follow the same experimental setup. In general, an MLP was compressed with two hidden layers and hidden size 256 compressed to only 0.2% of the original parameters. Such an extreme compression was seleced so that the problem is difficult enough to see variations in design decisions. Note that while the reported numbers of ˜85% accuracy are low for MNIST classification, training a linear classifier with [symbol] ₁ regularization and sparsifying to a similar number of parameters results in ˜79% accuracy. The default architecture of our generator has an input size of 9, two hidden layers of size 1,000, and an output size of 5,000. Note that

$$\frac{9 + 1}{5 , 000} = 0.002 .$$

For each experiment, the best learning rate was searched in {0.1,0.01,0.001} and report results averaged across three trials.

### Additional Ablation Experiments

Impact of varying k and d with fixed compression rate: The ratio of k to d determines its compression rate. Here, the input and output size of the random generator was multipled by an increasing constant factor keeping the compression rate fixed. The results are presented in Table 13. It is evident that a k value close to 1 leads to poor performance. As each generator input has an associated amplitude, the amplitude uses a larger percentage of the learnable parameters for smaller values of k. As k increases, the amplitude uses a much smaller percentage of the parameter budget, increasing the generator's ability to model complex functions.

TABLE 13
Impact of varying generator input and output size with
a fixed compression rate on MNIST classification.

| k | d | Acc. |
|---|---|---|
| 1 | 1000 | 69.3 ± 1.8 |
| 3 | 2000 | 78.4 ± 0.2 |
| 7 | 4000 | 83.2 ± 0.7 |
| 15 | 8000 | 84.9 ± 0.2 |
| 31 | 16000 | 85.8 ± 0.2 |

Effect of Generator weight initialization By representing the manifold as a randomly initialized neural network, it is able to easily be communicated using only a random seed. However, the space of possible random initialization schemes is large, and it is not clear what method of initialization would be most effective. To study this, generators were initiazlied where the weights are generated from both normal and uniform distributions with multiplying the variance of the distribution by a factor of c. As this multiplication also implicitly controls the input frequency, we always let c=1 for the first layer. The results of this experiment are shown in Table 14. It is clear from these results that drawing weights from a uniform distribution provides better performance than a normal distribution. In addition, results are higher when the variance is smaller. However, these results are likely intertwined with the selection of frequency in the first layer.

TABLE 14
The effect of generator weight initialization on
the accuracy of MNIST. We vary the scale of each
distribution by multiplying the variance by c.

| Initialization | c | Acc. |
|---|---|---|
| Uniform | 0.5 | 85.1 ± 0.2 |
| Uniform | 1.0 | 84.6 ± 0.0 |
| Uniform | 2.0 | 83.2 ± 0.9 |
| Uniform | 4.0 | 80.6 ± 1.6 |
| Uniform | 8.0 | 80.1 ± 0.8 |
| Normal | 0.5 | 81.8 ± 0.5 |
| Normal | 1.0 | 81.6 ± 0.2 |
| Normal | 2.0 | 82.1 ± 0.9 |
| Normal | 4.0 | 81.9 ± 0.2 |
| Normal | 8.0 | 82.0 ± 1.0 |

Effect of generator width and depth It's unclear how architecture variations in the generator of MCNC affect compression performance. To see the effect of generator hidden size, we construct generators with three layers and vary the hidden dimension and show results in Table 15. While accuracy initially improves, it quickly saturates suggesting there is not a benefit to infinitely increasing width. Likewise, the effect of depth was studied by constructing generators with a hidden size of 1000 and varying the number of layers. In addition, the effect of residual connections was experimented with as it is possible that increased depth causes our optimization to experience vanishing or exploding gradients. The results are showin in Table 16. Similarly, an improvement when extending beyond a single hidden layer is shown.

TABLE 15
The effect of generator hidden size on the accuracy of MNIST.

| Generator Width | Acc. |
|---|---|
| 64 | 83.5 ± 0.8 |
| 128 | 84.3 ± 0.4 |
| 256 | 84.3 ± 0.2 |
| 512 | 84.7 ± 0.8 |
| 1024 | 84.5 ± 0.5 |
| 2048 | 85.0 ± 0.7 |

TABLE 16
The effect of generator depth on the accuracy of MNIST.

| | Accuracy w/o Residual | |
|---|---|---|
| # of Layers | Conn. | Accuracy w/Residual Conn. |
| 2 | 83.7 ± 0.9 | N/A |
| 3 | 84.9 ± 0.8 | 83.9 ± 0.5 |
| 4 | 85.2 ± 0.1 | 84.0 ± 0.3 |
| 5 | 85.2 ± 0.8 | 84.0 ± 0.5 |

### Computation of Reconstruction FLOPS for LLaMA-2 7B and 13B

For Llama-2-7b, note that the model is composed of 32 layers. Each transformer layer can then be decomposed into 7 linear layers tow which the method of the present disclosure was applied:
1. 4 linear layers in the self-attention block each of size 4096×4096
2. 3 linear layers in the MLP block. Each has size 4096×11008. Note that the third layer comes from the gate of the SwiGLU activation function.

For both NOLA and the method of the present disclosure 8 was ranked which gives 11 matrices of size 4096×8 and 3 matrices of size 11008×8. Assuming the flops to generate each of these matrices can be computed, then the total flops would be:

$$32 * ( 11 * FLOPS ( 4096 \times 8 ) + 3 * FLOPS ( 11008 \times 8 ) )$$

For NOLA, use 64 basis so:

$$\begin{matrix}FLOPS ( 4096 \times 8 ) = 2 * 64 * 4096 * 8 = 4.19 MFLOPS \\ FLOPS ( 11 \; 008 \times 8 ) = 2 * 64 * 11008 * 8 = 11.27 MFLOPS \\ Giving a total of : 32 * ( 11 * 4.19 + 3 * 11.27 ) = 2.56 GFLOPS\end{matrix}$$

For MCNC, each run of the generator requires 2*(5*32+32*32+32*5000) operations. The number of forward passes necessary for each matrix is:

$$\begin{matrix}ceil ( \frac{4096 \times 8}{5000} ) = 7 \\ ceil ( \frac{11008 \times 8}{5000} ) = 18\end{matrix}$$

Each 5000 dimensional output was multipled by a single scalar, so the total number of operations is:

$$FLOPS ( 4096 \times 8 ) = 7 * 2 * ( 5 * 32 + 32 * 32 + 32 * 5000 ) + 7 * 5000 = 2.29 MFLOPS FLOPS ( 11008 \times 8 ) = 18 * 2 * ( 5 * 32 + 32 * 32 + 32 * 5000 ) + 18 * 5000 = 5.89 MFLOPS Giving a total of : 32 * ( 11 * 2.29 + 3 * 5.89 ) = 1.37 GFLOPS$$

For Llama-2-13b, the computation is the same except:
1. there are 40 layers
2. hidden dimension is 5120
3. intermediate size is 13824
4. LoRA rank is 16

### CONCLUSION

The present disclosure provides systems, methods, and apparatus for neural network compression through a technique called Manifold-Constrained Neural Compression (MCNC). This approach constrains the parameter space of neural networks to low-dimensional, pre-defined manifolds, effectively compressing the networks while maintaining high performance. MCNC may be applied to various neural network architectures and can be used in both training from scratch and parameter-efficient fine-tuning scenarios.

Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a”, “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes. Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

What is claimed:

1. A method for compressing a neural network, the method comprising:
partitioning parameters of a neural network into one or more segments;
initializing a generator network with random weights, the generator network configured to map from a lower-dimensional input space to a higher-dimensional parameter space;
freezing weights of the generator network;
initializing lower-dimensional inputs to the generator network;
generating neural network parameters by passing the lower-dimensional inputs through the generator network; and
training the neural network by optimizing only the lower-dimensional inputs while keeping the generator network fixed.

2. The method of claim 1, wherein the generator network comprises a feed-forward neural network with sinusoidal activation functions.

3. The method of claim 1, wherein a dimensionality of the lower-dimensional input space is at least 10 times smaller than a dimensionality of the higher-dimensional parameter space.

4. The method of claim 1, wherein training the neural network comprises:
receiving a batch of training data;
performing a forward pass through the neural network using the generated parameters;
calculating a loss based on outputs of the neural network;
backpropagating gradients through the neural network and the generator network to the lower-dimensional inputs; and
updating the lower-dimensional inputs using an optimizer.

5. The method of claim 1, further comprising:
after training the neural network, storing the generator network parameters and the optimized lower-dimensional inputs as a compressed representation of the neural network.

6. The method of claim 5, wherein storing the generator network parameters comprises storing a random seed used to initialize the generator network.

7. The method of claim 5, further comprising:
loading the compressed representation of the neural network;
reconstructing the full neural network parameters by passing the optimized lower-dimensional inputs through the generator network; and
performing inference using the reconstructed neural network parameters.

8. The method of claim 1, wherein the neural network comprises a vision transformer (ViT) architecture.

9. The method of claim 1, wherein the neural network comprises a residual neural network (ResNet) architecture.

10. The method of claim 1, wherein the neural network comprises a large language model (LLM).

11. A system for neural network compression, the system comprising:
a memory; and
a processor configured to:
partition parameters of a neural network into one or more segments;
initialize a generator network with random weights, the generator network configured to map from a lower-dimensional input space to a higher-dimensional parameter space;
freeze weights of the generator network;
initialize lower-dimensional inputs to the generator network;
generate neural network parameters by passing the lower-dimensional inputs through the generator network; and
train the neural network by optimizing only the lower-dimensional inputs while keeping the generator network fixed.

12. The system of claim 11, wherein the generator network comprises a feed-forward neural network with sinusoidal activation functions.

13. The system of claim 11, wherein a dimensionality of the lower-dimensional input space is at least 10 times smaller than a dimensionality of the higher-dimensional parameter space.

14. The system of claim 11, wherein the processor is further configured to:
after training the neural network, store the generator network parameters and the optimized lower-dimensional inputs as a compressed representation of the neural network.

15. The system of claim 14, wherein storing the generator network parameters comprises storing a random seed used to initialize the generator network.

16. The system of claim 14, wherein the processor is further configured to:
load the compressed representation of the neural network;
reconstruct the full neural network parameters by passing the optimized lower-dimensional inputs through the generator network; and
perform inference using the reconstructed neural network parameters.

17. A non-transitory computer-readable medium storing instructions that, when executed by a processor, cause the processor to perform operations comprising:
partitioning parameters of a neural network into one or more segments;
initializing a generator network with random weights, the generator network configured to map from a lower-dimensional input space to a higher-dimensional parameter space;
freezing weights of the generator network;
initializing lower-dimensional inputs to the generator network;
generating neural network parameters by passing the lower-dimensional inputs through the generator network; and
training the neural network by optimizing only the lower-dimensional inputs while keeping the generator network fixed.

18. The non-transitory computer-readable medium of claim 17, wherein the operations further comprise:
after training the neural network, storing the generator network parameters and the optimized lower-dimensional inputs as a compressed representation of the neural network.

19. The non-transitory computer-readable medium of claim 18, wherein the operations further comprise:
loading the compressed representation of the neural network;
reconstructing the full neural network parameters by passing the optimized lower-dimensional inputs through the generator network; and
performing inference using the reconstructed neural network parameters.

20. The non-transitory computer-readable medium of claim 17, wherein training the neural network comprises:
receiving a batch of training data;
performing a forward pass through the neural network using the generated parameters;
calculating a loss based on outputs of the neural network;
backpropagating gradients through the neural network and the generator network to the lower-dimensional inputs; and
updating the lower-dimensional inputs using an optimizer.
